(19) United States
(12) Patent Application Publication
(10) Pub. No.: US 2008/0239080 A1
(43) Pub. Date: Oct. 2, 2008

(54) Head-mounted rear vision system

(76) Inventor: Jonathan D. Moscato, Alden, NY (US)

Correspondence Address: Jonathan D. Moscato, 3460 Wende Road, Alden, NY, 14004, US

(21) Appl. No.: 12/077,978

(22) Filed: Mar. 24, 2008

Related U.S. Application Data
(60) Provisional application No. 60/920,021, filed on Mar. 26, 2007.
(60) Provisional application No. 60/937,379, filed on Jun. 27, 2007.

(51) Int. Cl. H04N 7/18

(52) U.S. Cl. 348/148; 348/118; 348/E07.085

(57) ABSTRACT

The rear vision system was invented to allow a bicycle, motorcycle rider, or an operator of any vehicle to safely and easily check his rear view without requiring the rider's head to be in a predetermined position. The system is comprised of a video camera which is mounted to a vehicle and facing its rear view and a head-mounted display which is connected to the video camera's output video signal. The head-mounted display is worn on the rider's head and allows the rider to see his rear view by simply glancing at the digital image, which is projected from the head-mounted display.

### CROSS-REFERENCE TO RELATED APPLICATIONS

This application claims the benefit of provisional patent application for Ser. No. 60/920,021 filed on Mar. 26, 2007 by the present inventor; Ser. No. 60/937,379 filed on Jun. 27, 2007 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to rear vision systems for vehicles, and more particularly to a system for providing a rider of a bicycle, motorcycle, or any driven vehicle with the capability of viewing the road behind his vehicle while facing forward, without requiring his head to be in a predetermine position.

2. Prior Art

Riders of bicycles and motorcycles must be aware of the traffic situation behind them when traveling on roadways. Currently a rider can turn his head to look at the road behind his vehicle. Looking back is not ideal because the rider has to physically rotate his head, taking his eyes off of the road ahead. Looking back may alter a vehicle's aerodynamics and may negatively impact balance and steering. Additionally, looking back can only be performed periodically, preventing continual knowledge of the traffic situation behind his vehicle.

Mirror arrangements are used to view the road behind a rider's vehicle. A mirror arrangement's reflected rear field of view is highly dependent on the viewer's perspective. Bicyclists and motorcyclists need to move their body and head position when riding, thereby altering a mirror's reflected rear field of view. Bicyclists are especially prone to head movement because they may stand when pedaling, crouch when coasting, and other times sit in a different posture on their seat.

Mirror systems can also reflect sunlight and vehicle headlights directly into a rider's eyes. Additionally, mirror systems lack the ability to brighten a nighttime view, or record a view for future use.

Side view mirrors are commonly mounted to vehicle handlebars. These mirrors are not ideal because of the above stated problem of rider perspective, and the mirrors are also susceptible to vibration, which can blur the reflected view. Additionally, the mirrors may negatively affect vehicle aerodynamics, and require the driver to look down which takes his eyes off of the road.

Head mounted mirrors attached to a helmet or a rider's glasses are also commonly used. These mirrors are not ideal because of the above stated problem of rider perspective. Another problem with head mounted mirrors is their adjustment can be time consuming and they are prone to misalignment when their mounting bracket is accidentally knocked by the rider. Additionally, head mounted mirrors must be mounted at a substantial offset from the riders head in order to have a complete rear view.

U.S. Pat. No. 6,493,882 to Steele (2002) discloses the use of a mirror arrangement for a rear view mirror system in an article of headgear especially for cycling or motorcycling. Steele's arrangement is prone to the above stated problem of rider perspective altering the arrangement's reflected rear field of view. Additionally, the arrangement is costly because it is integrated within a custom designed helmet.

U.S. Pat. No. 5,243,417 to Pollard (1993) discloses the use of a rear vision system for bicycles and motorcycles. The system is comprised of a rear facing camera mounted on a vehicle frame or under its seat, and a monitor mounted at a convenient place on the vehicle and attached by cable to the camera. This system is disadvantageous because it requires the driver to take his eyes off of the road in order to look down and focus on the monitor. Additionally, the monitor needs to be sufficiently large to display the rear view, which may block other vehicle instruments or cause aerodynamic drag. The monitor's view may also be susceptible to blurring due to vehicle vibration.

### BACKGROUND OF THE INVENTION—OBJECTS AND ADVANTAGES

It is therefore an object of the present invention to provide a novel rear vision system devoid of the above noted disadvantages of the prior-art.

It is another object of the present invention to create a rear vision system that does not require the user to position himself at a specific perspective in order to attain the proper view of the road behind him, but instead provides a fixed and constant rear view, independent of the rider's head and body position.

It also is an object of the present invention to create a rear vision system that is easy to view because it is unaffected by vehicle transmitted vibrations.

It is a further object of the present invention to create a rear vision system that does not require a display to be mounted on the vehicles frame or handlebars which may block other instruments, may cause aerodynamic drag, and requires the rider to look down thereby taking his eyes off of the road ahead.

It is still a further object of the present invention to create a rear vision system that is capable of being viewed by the user without the need to turn his head away from the road in front of him.

Another further object of the present invention is to create a rear vision system that can digitally enhance a view by providing image stabilization, night time viewing, bright light suppression, automatic iris, background light intensity level adjustment, and the ability to focus on the rear field of view.

It is another object of the present invention to create a rear vision system that can record the view for later use.

It is still another object of the present invention to create a rear vision system that supplies a video to the rider that is a mirrored image of the actual view.

These and additional objects of this invention are accomplished generally speaking by a novel rear vision system consisting of a video camera mounted to the seat or frame of a bicycle or motorcycle and aimed at the rear view of the vehicle and a head-mounted display which the rider wears to view the video camera's real time video output of the rear view.

### DRAWINGS—FIGURES

FIG. 1 illustrates a rider on a bicycle using the rear vision system.

FIG. 2 illustrates a rider on a motorcycle using the rear vision system.

FIG. 3 illustrates a driver in a car using the rear vision system.

FIG. 4 shows the back side of the video camera.

FIG. 5 shows the front side of the video camera.

FIG. 6 shows the exploded view of the video camera.

FIG. 7a & b shows a front and side view of the head-mounted display with the eyes in the horizontal line of sight.

FIG. 8a & b shows a front and side view of the head-mounted display with the eyes in the upper line of sight.

FIG. 9 shows an exploded view of the head-mounted display.

### DRAWINGS—REFERENCE NUMERALS

1 rider
2 bicycle
3 video camera
4 head-mounted display
5 horizontal line of sight
6 upper line of sight
7 video camera line of sight
8 motorcycle
9 video camera remote control
10 safety helmet
11 car
12 head braise
13 ON/OFF button
14 CCD Camera (with mirrored output)
15 recharge terminal
16 video/power output terminal
17 mounting interface
18 rechargeable battery pack
19 video jack
20 power jack
21 voltage regulator
22 video cable
23 binocular display
24 goggles
25 display housing

### SUMMARY OF THE INVENTION

One aspect of the rear vision system enables a rider of a bicycle or motorcycle to view the road behind him by showing a live image of the rider's rear view on the system's head-mounted display (HMD). The head-mounted display shows the live output of a video camera which is mounted to the rear of the bicycle or motorcycle.

The rear mounted camera is aimed at the road behind the rider and locked in place. The fixed camera provides a constant rear field of view to the rider while allowing the rider the necessary freedom of movement. The head-mounted display allows the rider to simply glance at the known fixed position of the head-mounted display, providing a constant rear view image which is independent of the rider's head and body position. When the head-mounted display is properly secured to the rider's head, the view is isolated from the majority of vehicle vibrations, providing a clear and focused image of his rear view.

Preferably the video supplied to the rider had been digitally or optically mirrored so as to supply a mirrored image of the actual view to the rider.

Head-mounted displays are typically comprised of either one or two small cathode ray tube (CRT), liquid crystal display (LCD), liquid crystal on silicon (LCoS), or organic light-emitting diode (OLED) displays with magnifying lenses embedded in a helmet, glasses or visor. Lenses are used within head-mounted displays to give the perception that the images are coming from a greater distance, to prevent eye strain. Some head-mounted or wearable glasses may also be used to view a see-through image imposed upon a real world view, creating what is called augmented reality. This is done by reflecting the video images through partially reflective mirrors.

Preferably the head-mounted display is comprised of a display mounted to the rider's goggles or helmet in such a configuration that the rider can see a clear view of the display when looking in his upper line of sight, and also see an unobstructed view of the road ahead when looking at his horizontal line of sight.

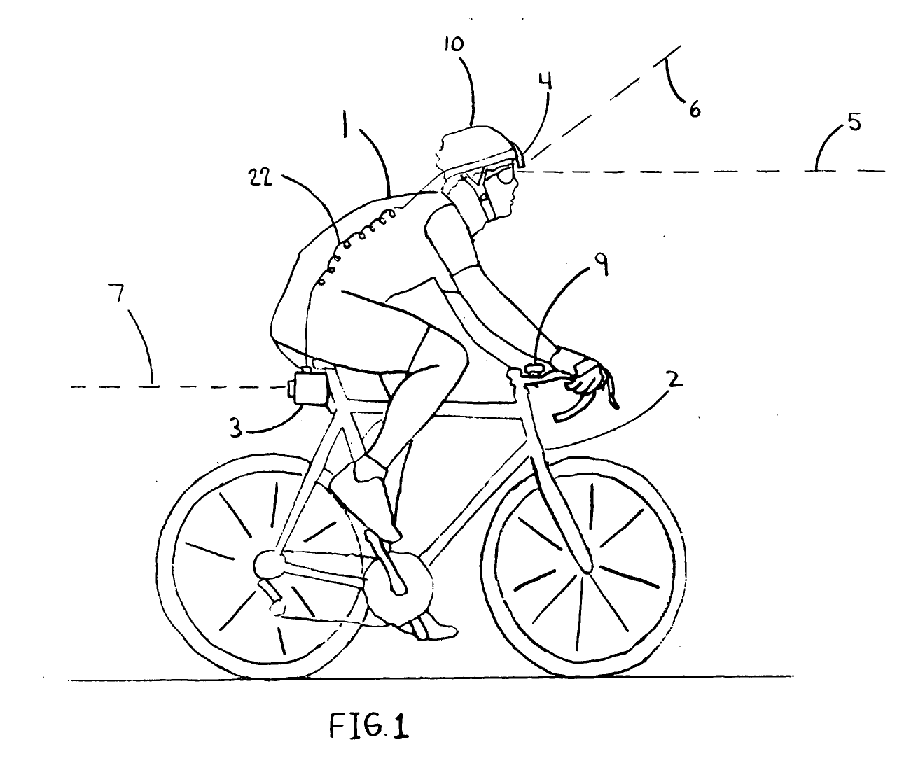

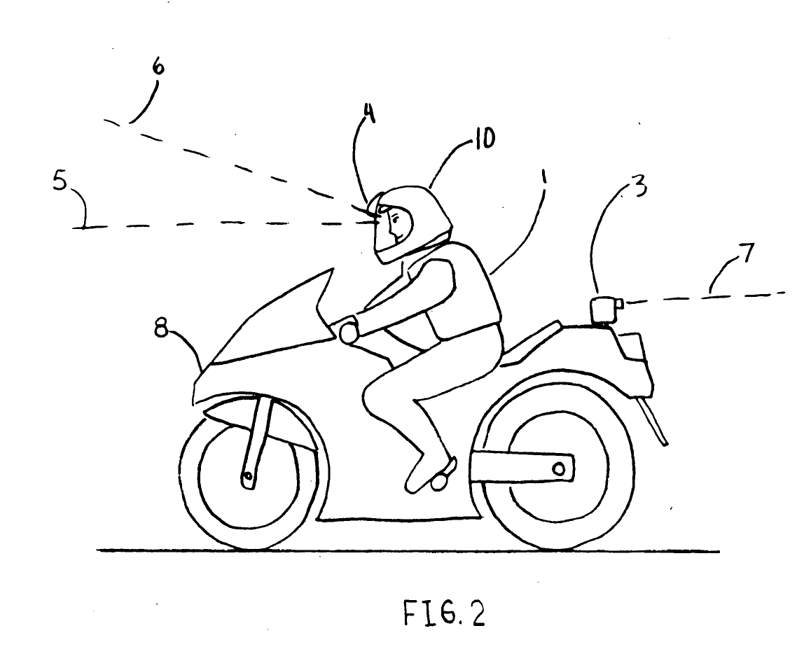

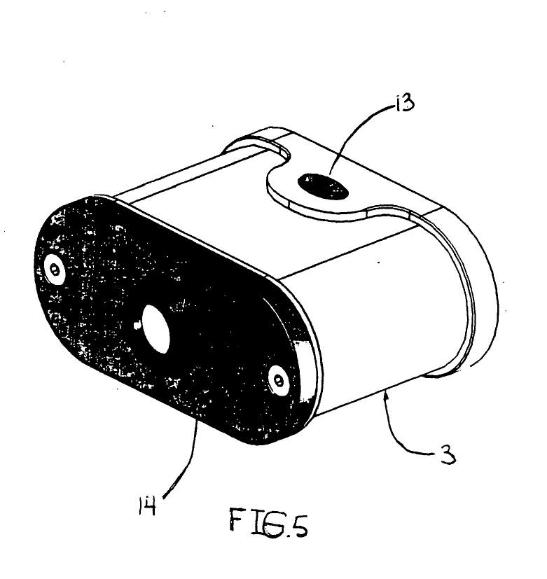

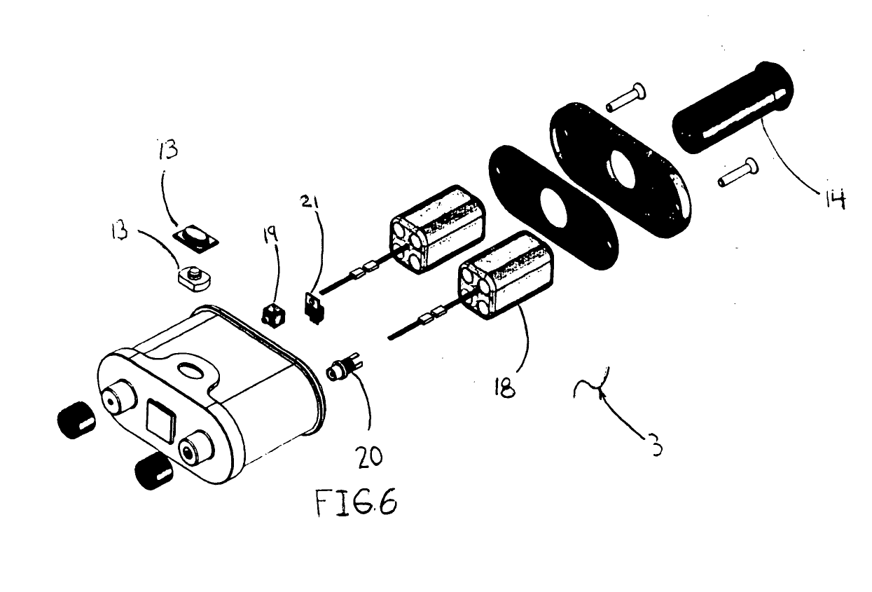

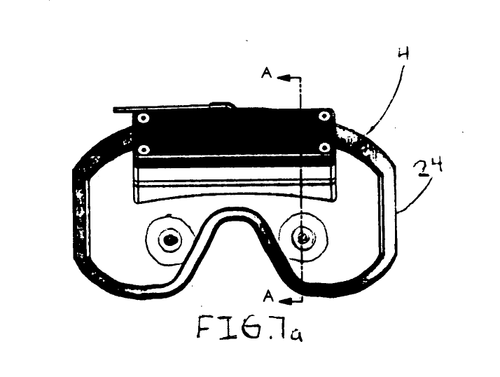

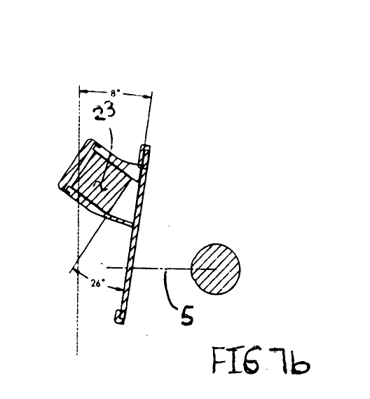

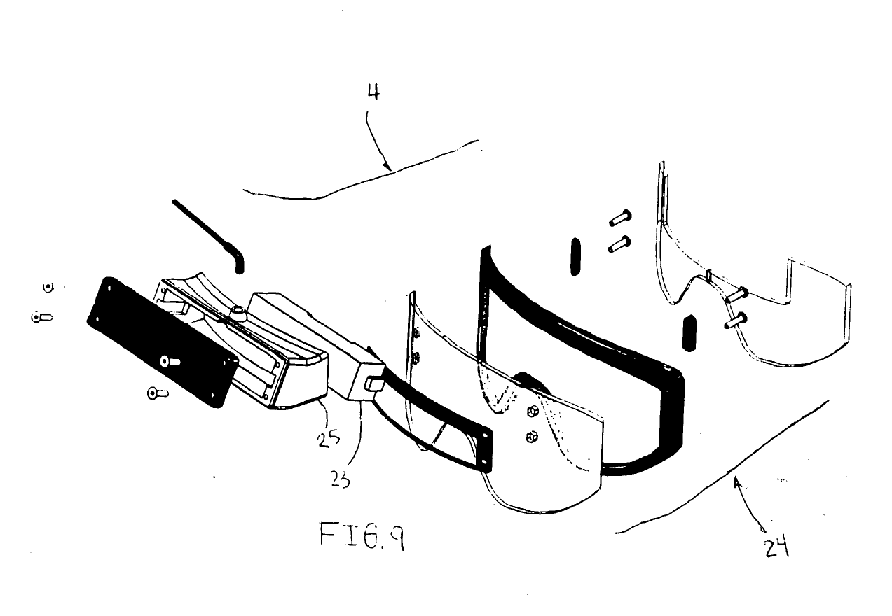

### DETAILED DESCRIPTION—FIG. 1 & FIGS. 4-10—THE PREFERRED EMBODIMENT

As shown in FIG. 1 & FIGS. 4-9 the preferred embodiment of the rear vision system is comprised of video camera 3 which is attached to the seat post of bicycle 2 via a camera mounting bracket. Head mounted display 4 is worn by rider 1 and connected to video camera 3 via video cable 22.

The camera mounting bracket is adjusted to set video camera 3 to the proper line of sight 7 and the camera's field of view, so that rider 1 can view the lane of approaching traffic sufficiently.

Video camera 3 has a SHARP ⅓″ CCD color camera 14, which has switchable backlight compensation, electronic shutter control, and digital mirror output. In order to attain the desired field of view, the camera has a 12 mm fixed lens.

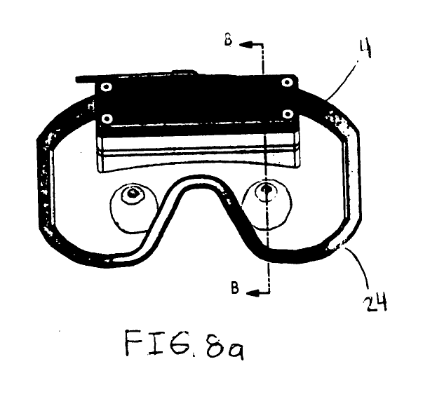

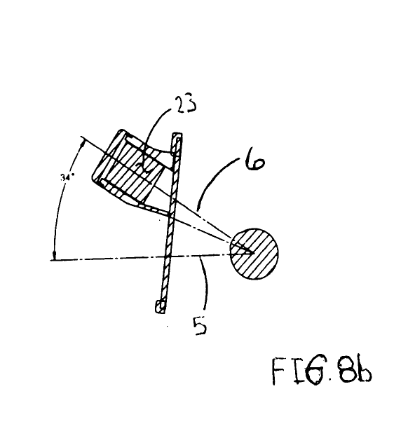

The preferred embodiment has a head-mounted display which is comprised of binocular LCD display 23, which is a KOPIN BDM-230J binocular display with QVGA-quality 320×240 resolution video output. The display is mounted to goggles 24 via display housing 25. FIG. 7a & b shows the head-mounted display configuration with the rider's eyes positioned in his horizontal line of sight 5, looking at the road ahead. FIG. 8a & b show the rider looking at his upper line of sight 6 in order to view the images shown on the display.

### Additional Options of the Preferred Embodiment—FIG. 1

The camera mounting bracket is preferably mounted to the seat post of bicycle 2 and alternately can be mounted to the bicycle frame or attached to any point on the bicycle which provides a sufficient mount and sufficient rear view. The camera mounting bracket is preferably a rigid mount, and alternately may utilize shock and vibration isolation mounts to protect the camera from excessive excitation.

Video camera 3 is preferably attached to head-mounted display 4 via video cable 22 and alternately may be in communication via radio frequency.

Video camera 3 can alternately be operated by remote control 9 which may be mounted to the handlebars of bicycle 2. Alternately camera 3 can be operated by the controls mounted on the camera. Preferably remote control 9 has a control button to command camera 3 to broadcast a live video signal.

Preferably head-mounted display 4 is positioned at upper line of sight 6, which is above horizontal line of sight 5. Alternately, head-mounted display 4 may be positioned on line of sight 5, or below line of sight 5.

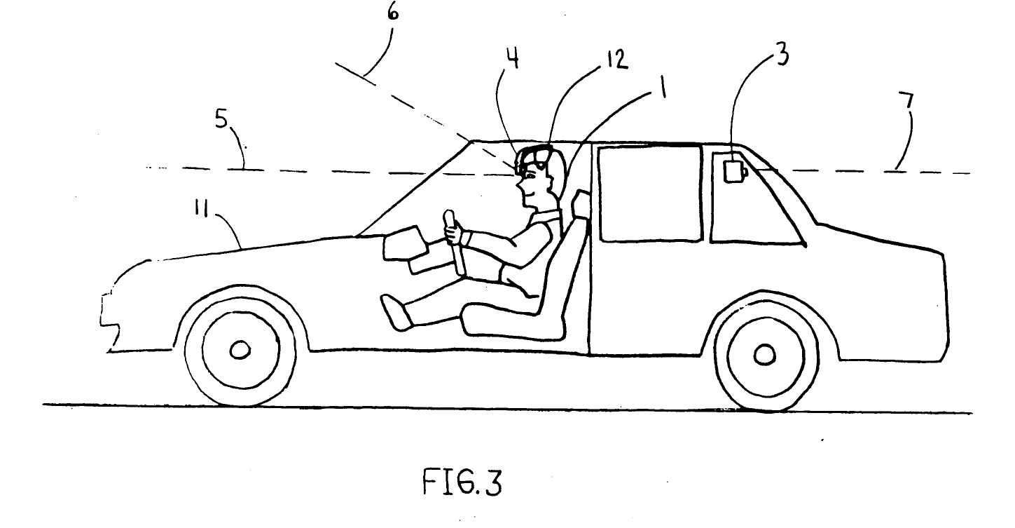

### Second Embodiment—FIG. 2

The second embodiment is the same as the preferred except the vehicle is a motorcycle and the camera is mounted to the motorcycle in a convenient location to view the road behind the rider.

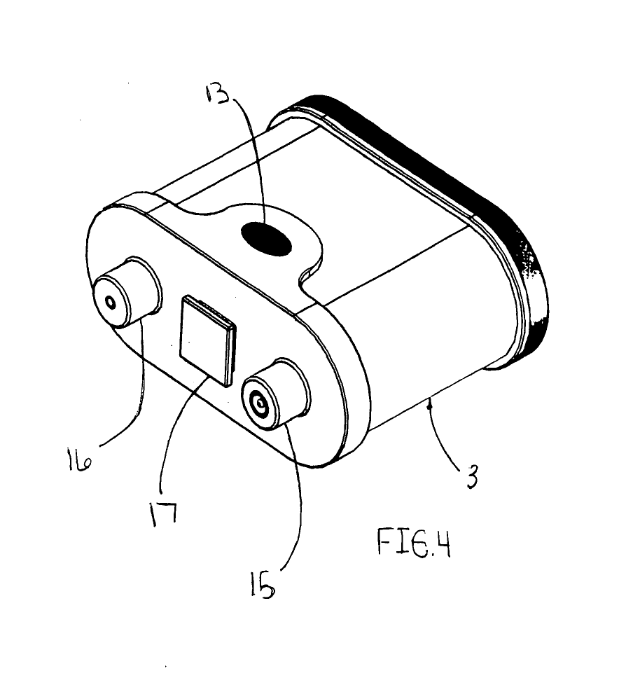

### Third Embodiment—FIG. 3

The third embodiment is the same as the preferred except that the vehicle is any motorized, human powered, or human controlled vehicle in which it is desired to see the vehicle's rear view. These vehicles include but are not limited to cars, busses, trucks snowmobiles, water borne vessel, aircraft, and all terrain vehicles.

### Conclusions, Ramifications, and Scope

Thus, the reader will see that providing a rider with a real time image of the road behind him while giving him the freedom to have his head and body in any position, and without requiring him to take his eyes off of the road by either looking down or over his shoulder will increase his knowledge of the traffic situation behind him without the above mentioned disadvantages.

The rear vision system can be designed alternately to show other information important to the rider such as speed, direction, temperature, GPS map location, RPM, radar detection status, vehicle gear, engine temperature, elevation, and rider heart rate.

The rear vision system can alternately be mounted on an elevated rear mounted platform in order to view the road from an elevated perspective.

The rear vision system can alternately be arranged to show the side view of the road next to the rider. This can be achieved with a fisheye camera aimed at the side view, or with a camera that automatically or manually moves to and from a side view. Furthermore the camera may automatically move to or transmit an image of the vehicle's side view when the system detects that the vehicle is about to turn in the associated direction.

The rear vision system can alternately have a camera mounted to the rear of the rider's head supported structure, such as a helmet, to provide a rear view.

The rear vision system's head-mounted display may be integrated with various head supported structures including goggles, helmets, eyewear, headbands, or any head supported structure which supports and positions a display such that a digital image is projected into the rider's eyes.

The display may be located inside or outside the head supported structure. For example, the display could be installed within the interior or exterior region of goggles or a helmet.

The digital image signal may be communicated from the video camera to the head-mounted display by various signal means including electrical wires, fiber optics, radio signal, infrared, or any other means capable of transmitting a digital image signal.

Thus the scope of the invention should be determined by the appended claims and their legal equivalents, rather than the examples given.

I claim:

1. A rear vision system for providing a rider of a vehicle with an image of the view behind his vehicle independent of the rider's head position, said system comprising;
a video camera mounted to the vehicle and aimed at the vehicle's rear view;
a display, connected to the video camera for showing the live output video signal of the video camera, and worn on the rider's head at a position visible to the rider;
whereby the rider can safely and easily check his rear view at any head position.

2. The rear vision system of claim 1 wherein said vehicle is a bicycle.

3. The rear vision system of claim 1 wherein said vehicle is a motorcycle.

4. The rear vision system of claim 1 wherein said vehicle is a car.

5. The rear vision system of claim 1 wherein said vehicle is a truck.

6. The rear vision system of claim 1 wherein said vehicle is a water borne vessel.

7. The rear vision system of claim 1 wherein said vehicle is a aircraft.

8. The rear vision system of claim 1 wherein said vehicle is an all terrain vehicle.

9. The rear vision system of claim 1 wherein said camera produces a mirrored image of the rear view.

10. The rear vision system of claim 1 wherein said display outputs a mirrored image of the rear view.

11. The rear vision system of claim 1 wherein said rear facing camera is mounted to an elevated platform.

12. The rear vision system of claim 1 wherein said rear facing camera transmits an image of the vehicle's side view.
